(19) United States
(12) Patent Application Publication
(10) Pub. No.: US 2026/0021808 A1
(43) Pub. Date: Jan. 22, 2026

(54) RESPONSE SYSTEM FOR A VEHICLE

(71) Applicant: Federal Signal Corporation, Downers Grove, IL (US)

(72) Inventors: Joseph F. Bader, Monee, IL (US); Michael K. Pula, Naperville, IL (US); Paul M. Gergets, Saint John, IN (US)

(21) Appl. No.: 19/269,288

(22) Filed: Jul. 15, 2025

Related U.S. Application Data
(60) Provisional application No. 63/672,040, filed on Jul. 16, 2024.

(51) Int. Cl. B60W 30/09; G06V 20/40; G06V 20/58

(52) U.S. Cl. CPC B60W 30/09; G06V 20/44; G06V 20/58; B60W 2420/403; B60W 2556/45; G06V 2201/10

(57) ABSTRACT

Automated response system for vehicles. A device associated with a vehicle automatically performs an action based on a detected event in the vicinity of the vehicle. The event is captured on video footage that is processed locally at the vehicle to categorize the event. The categorization is sent to a remote processing device. The remote processing device generates a signal that causes the device associated with the vehicle to respond in a particular way to the detected event.

### BACKGROUND

Vehicles, such as emergency vehicles, can be equipped to respond to events occurring outside the vehicle. For example, in response to a hazardous condition on a roadway, an operator of the emergency vehicle may activate warning lights and/or a siren to warn other vehicles and pedestrians of the potential danger, or turn on a camera to capture footage of the scene for later analysis.

### SUMMARY

In general terms, the present disclosure relates to a system for autonomously responding to events occurring in the vicinity of vehicles.

In one aspect, the present disclosure relates to a system for responding to events. The system may include a vehicle, and a camera mounted to the vehicle. The camera may be configured to capture video footage or utilize a visual sensor array to capture a numerical data stream. The system may also include a first electronic computing device mounted to the vehicle, the first electronic computing device including at least one processor and memory encoding instructions which when executed by the at least one processor, the memory encoding instructions cause the first electronic computing device to process, by the at least one processor, the video footage or analyze the numerical data stream. Based on the processed footage and/or numerical data stream, the first electronic computing device detects an event in the video footage or numerical data stream to provide a detected event and assigns a predefined event type to the event. The information is then transmitted as first signals to a second electronic computing device that is remote from the vehicle, the first signals indicating an occurrence of the predefined event type. The at least one processor then processes the second signals transmitted from the second electronic computing device and based on the second signals, causes a device or multiple devices associated with the vehicle or event category to respond to the detected event with a response.

Another aspect of the present disclosure may include a system for responding to events, including a first electronic computing device. The first electronic computing device may include at least one processor and memory encoding instructions which, when executed by the at least one processor, cause the first electronic computing device to process, by the at least one processor, first signals transmitted from a second electronic computing device mounted to a vehicle that is remote from the first electronic computing device. The first signals may indicate an occurrence within a visual range of the vehicle of a predefined event type, the occurrence being determined from video footage or numerical data from a visual sensor array. The system then generates second signals configured to cause a device associated with the vehicle to respond to the detected event with a response, the second signals being generated based on the predefined event type.

Another aspect of the present disclosure may include a system for responding to events, including a vehicle, a response device associated with the vehicle, a camera or cameras mounted to the vehicle and being configured to capture video footage or stream numerical data, a first electronic computing device mounted to the vehicle and including at least one first processor; and a second electronic computing device that is remote from the vehicle and including at least one second processor. The first electronic computing device may include memory encoding first instructions and the second electronic computing device may include memory encoding second instructions. When executed by the at least one first processor and the at least one second processor, respectively, the memory encoded first instructions and second instructions may cause the first electronic computing device and the second electronic computing device to process, by the at least one first processor, the video footage or numerical data and, based thereon, detect, by the at least one first processor, an event in the video footage or numerical data stream to provide a detected event and assign, by the at least one first processor, a predefined event type to the event. Once the predefined event is assigned, the system may generate, by the first electronic computing device, first signals indicating an occurrence of the predefined event and transmit, by the first electronic computing device, the first signals to the second electronic computing device. The second electronic computing device will then generate second signals based on the predefined event type and transmit, by the second electronic computing device, the second signals. The second signals are then processed, by the at least one first processor, and based on the second signals, third signals are generated. The response device then receives the third signals and, based on the third signals, to respond to the detected event with a response; and wherein the video footage or numerical data is not provided to the second electronic computing device.

According to another aspect, the present disclosure relates to a system for responding to events, including: a vehicle; a camera mounted to the vehicle, the camera being configured to capture video footage; a first electronic computing device mounted to the vehicle, the first electronic computing device including: at least one processor; and memory encoding instructions which, when executed by the at least one processor, cause the first electronic computing device to: process, by the at least one processor, the video footage and, based thereon: (i) detect an event in the video footage to provide a detected event; and (ii) assign a predefined event type to the event; transmit first signals to a second electronic computing device that is remote from the vehicle, the first signals indicating an occurrence of the predefined event type; process, by the at least one processor, second signals transmitted from the second electronic computing device; and based on the second signals, cause a device associated with the vehicle to respond to the detected event with a response.

According to another aspect, the present disclosure relates to a system for responding to events, including: a first electronic computing device, including: at least one processor; and memory encoding instructions which, when executed by the at least one processor, cause the first electronic computing device to: process, by the at least one processor, first signals transmitted from a second electronic computing device mounted to a vehicle that is remote from the first electronic computing device, the first signals indicating an occurrence within a visual range of the vehicle of a predefined event type, the occurrence being determined from video footage; and generate second signals configured to cause a device associated with the vehicle to respond to the detected event with a response, the second signals being generated based on the predefined event type.

According to another aspect, the present disclosure relates to a system for responding to events, including: a vehicle; a response device associated with the vehicle; a camera mounted to the vehicle, the camera being configured to capture video footage; a first electronic computing device mounted to the vehicle and including at least one first processor; and a second electronic computing device that is remote from the vehicle and including at least one second processor, the first electronic computing device including memory encoding first instructions and the second electronic computing device including memory encoding second instructions which, when executed by the at least one first processor and the at least one second processor, respectively, cause the first electronic computing device and the second electronic computing device to: process, by the at least one first processor, the video footage and, based thereon: (i) detect, by the at least one first processor, an event in the video footage to provide a detected event; and (ii) assign, by the at least one first processor, a predefined event type to the event; generate, by the first electronic computing device, first signals indicating an occurrence of the predefined event; transmit, by the first electronic computing device, the first signals to the second electronic computing device; generate, by the second electronic computing device, second signals based on the predefined event type; transmit, by the second electronic computing device, the second signals; process, by the at least one first processor, the second signals; and based on the second signals, generate, by the first electronic computing device, third signals, wherein the response device is configured to receive the third signals and, based on the third signals, to respond to the detected event with a response; and wherein the video footage is not provided to the second electronic computing device.

According to another aspect, the present disclosure relates to a system for responding to events, including: a vehicle; a visual sensor array mounted to the vehicle, the visual sensor array being configured to capture video footage; a first electronic computing device mounted to the vehicle, the first electronic computing device including: at least one processor; and memory encoding instructions which, when executed by the at least one processor, cause the first electronic computing device to: process, by the at least one processor, the video footage to encode the video footage as a numerical data stream and, based thereon: (i) detect an event in the numerical data stream to provide a detected event; and (ii) assign a predefined event type to the event; transmit first signals to a second electronic computing device that is remote from the vehicle, the first signals indicating an occurrence of the predefined event type; process, by the at least one processor, second signals transmitted from the second electronic computing device; and based on the second signals, cause a device associated with the vehicle to respond to the detected event with a response.

### BRIEF DESCRIPTION OF THE DRAWINGS

FIG. 1 is a schematic view of an example response system for a vehicle according to the present disclosure.

FIG. 2 is an example method that can be performed by the system of FIG. 1.

FIG. 3 schematically illustrates an example computing device of the response system of FIG. 1.

### DETAILED DESCRIPTION

Vehicles are equipped to respond automatically to certain kinds of events. For example, if a sensor on a vehicle detects that the vehicle is moving and approaching contact with another object, a control system of the vehicle may cause the vehicle automatically to brake to avoid a collision, or to sound an alarm or generate vibration that can felt by the driver.

Vehicle detection and response systems are inherently limited in the number of different types of events that can be discerned and, consequently, in the number of different event-specific responses that can be generated as responses to different events. One aspect that limits the robustness of vehicle detection and response systems in these and other ways is the vast amount of environmental data that must be collected and processed to accurately identify different types of events in a timely manner.

Vehicle detection and response systems are also inherently limited in how a response to a detected event is selected. For instance, the vehicle may respond inappropriately based on incomplete data. Similarly, an occupant of the vehicle who is notified about the detected event may respond inappropriately, e.g., as a result of being distracted by the event or by operating the vehicle. However, transmitting the vast amounts of environmental data captured at the vehicle (e.g., by one or more video cameras) offsite to a remote third party device or entity that then determines how to respond is impractical due to transmission bandwidth constraints and the need, often, to respond to events around a vehicle quickly, e.g., in matter of 10 seconds, or five seconds, or less.

The present disclosure can alleviate one or more of these drawbacks associated with vehicle detection and response systems. In particular, aspects of systems of the present disclosure that can improve upon existing vehicle detection and response systems include locally processing and analyzing video footage at the vehicle and transmitting event categorizations determined at the vehicle to a remote location that is, e.g., (more than one mile, more than five miles, more than 10 miles, more than 25 miles, more than 50 miles, more than 100 miles, more than 1,000 miles, or more away from the vehicle) determines an appropriate response that is then communicated to one or more devices local to (e.g., within 500 feet, or within 100 feet, or within 50 feet, or within 25 feet, or within 10 feet, or within 5 feet of the vehicle or on or within the vehicle) and associated with the vehicle.

As used herein, processing captured video footage can encompass different forms of encoding typical video streams (e.g., a motion JPEG) as numerical bit streams.

As used herein, capturing video footage can include, e.g., capturing moving picture frames using a camera, capturing a numerical data stream from a visual sensor array, and the like.

A system as disclosed herein can observe conditions in the surrounding environment of a vehicle using one or more detectors (e.g., a video camera, a visual sensor array, a motion sensor, a radar detector, a lidar detector, a microphone, a light sensor, an infrared sensor, and the like) to capture data associated with an event and analytically process the captured data to determine what the event is. For example, the system can include a video analytics module local to the vehicle that processes video footage captured by the vehicle's video camera. Other local analytics modules can be configured to analyze data from other types of detectors. The video analytics module (and/or other analytics modules) can include a machine learning model trained to output a predicted event type based on learned input data that includes the captured data. The output (i.e., the determined event type) is transmitted to a remote location, such as a command center or dispatch center which then determines how to respond to the detected event. In some cases, the remote device generates and transmits a signal back to the vehicle that causes the vehicle or a device associated with the vehicle (e.g., a body mounted camera of an officer within a predefined distance of the vehicle) to perform an action in response to the detected event.

In some examples, the remote computing device (e.g., at a command center) determines, based on one or more predefined rules, that the occurrence of the event should be recorded, whether or not a response to the detected event by a device associated with the vehicle is warranted. In these situations, the remote computing device can save, e.g., in a table stored on a database, data and metadata about the detected event, such as the event type, when it occurred, the vehicle detection device that captured the underlying event data, an identification of the vehicle, a location of the vehicle when the event was detected, an identification of an individual (e.g., an officer) associated with the vehicle at the time of the event, as well as environmental conditions at the vehicle, such as temperature, humidity, visibility, light intensity, and the like. Such data and metadata can be transmitted to the remote device from the local device at the vehicle, but without the underlying video footage. In some examples, in addition to recording information about the event, the remote computing device can send signals to a device associated with the vehicle in question to cause that device to respond to the event.

The system can be configured, or trained, to recognize many different types of events, and to curate and generate responses specific to each type of event when it is detected. The events could relate to an emergent scenario or a non-emergent scenario. The system can allow for faster, more efficient, and more appropriate and effective responses to the different events, without the need for the information to be processed and analyzed by a human source.

However, in some examples, a person at the remote location can be involved in crafting a response to the detected event and to provide input to the remote computing device that causes the remote computing device to generate and send a signal to a device associated with the vehicle, causing the device associated with the vehicle to behave in a certain way and generate an appropriate response to the event. A person at the remote location may be better equipped with additional information from other sources to determine an appropriate response to a detected than a person at the event who may be under stress or duress, or otherwise judgment-impaired.

The vehicle of the system herein can be an emergency vehicle (e.g., a fire truck, an ambulance, a police car, a tow truck), a passenger vehicle, a helicopter, an aircraft, an unmanned vehicle, a train, a boat, and the like.

The system can be configured to process and recognize many different event types from video footage (alone, or in combination with other detector data or sensor data) such as, but not limited to, recognition of: a weapon, a threatening crowd, a verbal request for help, a person in distress, a person incapacitated, a mutual combat scenario, an altercation with an officer, an emergency responder down, a collision of another vehicle near the vehicle, an argument, a gun shot, an explosion, a pedestrian struck by a vehicle, an issue with building structural integrity, a person entering or exiting a particular building, placing a person on a gurney, a power line down, a tree down, a crushed vehicle, a flipped vehicle, a number of occupants in a vehicle, an attack by an animal, a speeding vehicle, a person scaling a fence, a person on an airfield or other unauthorized or restricted access location, a person in a window, a person on a roof, the presence of other emergency vehicles, a worker down, identification of a tornado or other type of weather, identification of debris on a roadway, a damaged roadway sign, high sound levels, a damaged road or bridge, a vehicle offroad, a pursuit, lightening, flying debris, detection of poor visibility, a falling vehicle, or an officer drawing a weapon.

The system is configured to determine the event type. The system is also configured to generate metadata associated with the event, such as the time of occurrence of the event based on a time stamp from the relevant captured video footage, the location of the event based on, e.g., GPS or other location device data generated by the vehicle or a device at or near the vehicle at the time the event was captured on video, and the identification of any personnel known to be operating n the vehicle at the time the event was captured on video.

Devices associated with the vehicle that can respond to the detected event based on input received from the remote computing device can be mounted directly to the vehicle, to a location near the vehicle, to a person associated with vehicle (e.g., an officer operating the vehicle), and the like. Such devices can include, but are not limited to, radios, video cameras (e.g., a dash camera, a body camera), microphones, lights (e.g., spot lights, warning lights), sirens, electric speakers, amplifiers, a vehicle movement controller (e.g., one or more controllers that can speed up, slow down, and/or steer the vehicle, or operate a vehicle component, such as opening or closing a window of the vehicle), a display (e.g. in the vehicle or on a smart device carried by a person associated with the vehicle) that provides the person associated with the vehicle with information about the event and/or instructions for how to respond to the event, a portable device (e.g., a smart device) carried by a person associated with the vehicle and the like.

The system is configured to generate many response types using the remote computing device and the device associated with the vehicle based on the event type detected and metadata associated with the captured event. Such response types can include, but are not limited to: sounding an alarm or a warning message, turning on or off a light or generating a warning light pattern, activating a video camera so that it collects footage, activating a microphone so that it collects sound, activating a speaker and generating sound thereby, messaging s communications device (e.g., a radio or smartphone associated with the vehicle), activating a weapon, speeding up the vehicle, slowing down the vehicle, steering the vehicle, putting up a window of the vehicle, putting down a window of the vehicle, sending information about the detected event and/or instructions for responding to the detected event for display on a display device, and the like.

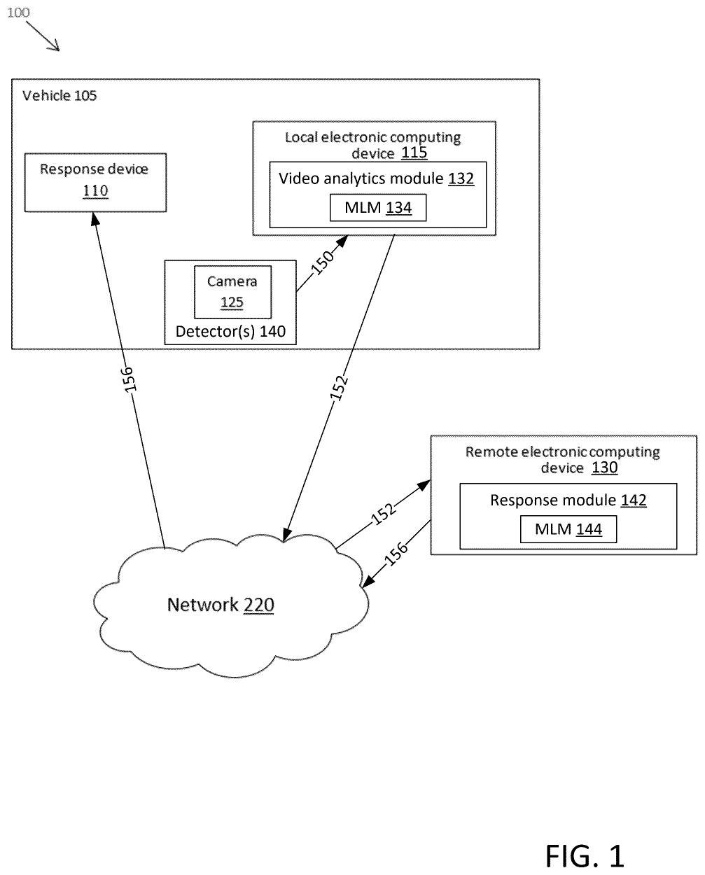

FIG. 1 is a schematic view of an example response system 100 for vehicles.

Referring to FIG. 1, the system 100 includes a vehicle 105, a response device 110, one or more detectors 140, a local electronic computing device 115, and a remote electronic computing device 130.

The detector(s) 140 can include a camera 125. Additionally, and/or alternatively, the detector(s) 140 can include one or more of e.g., a visual sensor array, a motion sensor, a radar detector, a lidar detector, a microphone, a light sensor, an infrared sensor, and the like.

The vehicle 105 can be any vehicle as described herein.

The response device 110 can be any type of response device as described herein. The response device 110 is associated with the vehicle 105 in any manner described herein. For instance, the response device 110 could be mounted to an exterior surface or an interior surface of the vehicle 105. The response device 110 could be carried by a person associated with the vehicle 105, as described herein. The vehicle 105 can include any number of response devices of different types as described herein.

The camera 125 is mounted to the vehicle 105. For example, the camera 125 is mounted to a dash, or to a windshield, or to an exterior surface of a body of the vehicle. The camera 125 is configured to capture video footage of the vehicle's surroundings. The camera 125 can be an electronic video camera that captures digital footage. The camera 125 can include a controller for controlling, e.g., when the camera is rolling, and controlling offloading captured footage to the local electronic computing device 115. The vehicle can include additional cameras 125, e.g., mounted at different locations to the vehicle 105. In some examples, the video footage that is analyzed by the local computing device is captured by multiple cameras (e.g., showing different zones or areas around the vehicle), which may be necessary to accurately detect certain types of events, such as an event type of an emergency vehicle being about to be surrounded by animals or people.

The vehicle 105 can include other detectors 140 or data collection devices in addition to the camera 125 or cameras, and as described herein.

The local electronic computing device 115 is mounted to the vehicle 105, e.g., within the cab of the vehicle or within the engine well of the vehicle. The computing device 115 includes a processor and non-transitory computer-readable storage that stores a video analytics module 132 executable by the processor. In some examples, the video analytics module includes a machine learning model (MLM) 134.

In some examples, a dedicated housing can house the camera 125 and the computing device 115, with the dedicated housing being removably installed in the vehicle 105, and/or allowing the vehicle 105 to be retrofitted with the capabilities of the system 100 described herein.

In some examples, there is a hard connection (e.g., one or more wires) connecting the camera 125 and the local electronic computing device 115, such that signals corresponding to raw footage captured by the camera 125 are sent via hard connection to the device 115. In other examples, there is no hard connection between the camera 125 and the device 115, and raw footage signals can be sent to the device 115 from the camera 125 via other means, e.g., a near field communication network.

The camera 125 and/or the computing device 115 can include a clock and a geolocation device (e.g., a GPS device) such that metadata providing when and where footage is taken can be generated with the raw footage itself. Similarly, various sensors or detectors can supply additional metadata contemporaneously with footage being captured and supply such metadata to the computing device 115, such as temperature metadata, humidity metadata, light intensity metadata, sound intensity metadata, precipitation metadata, elevation metadata, angle of the vehicle 105 relative to the horizontal metadata, direction of vehicle travel metadata, and the like.

The remote computing device 130 is located remotely from the vehicle 105, e.g., at least one mile up to hundreds of miles or more away from the vehicle 105. For example, the remote computing device 130 can be located at a command center, a control center, a police station, a fire station, an air traffic control room, an airport, and the like. The remote computing device 130 includes a processor and non-transitory computer-readable storage that stores a response module 142 executable by the processer. In some examples, the response module 142 includes a machine learning model (MLM) 144. In some examples, the response module 142 accesses a machine learning model via the network 220.

The remote computing device 130, the local electronic computing device 114, and the response device 110 are networked together via any suitable network 220, such as a WiFi network, a cellular network, a satellite network, combinations of networks, and the like. The network 220 enables signals to be transmitted between the various devices for performing the capabilities of the system 100.

In an example use case for the system 100, the camera 125 captures raw digital video footage of an event at or in the vicinity of the vehicle 105. In some examples, the camera 125 is already or continuously rolling prior to the event occurrence. In other examples, another detector 140, e.g., a sensor, detects a stimulus (e.g., light, sound, motion) that triggers the camera 125 to start rolling and capture footage. In some examples, a person activates the camera 125 to start rolling.

The detector(s) 140 capture event-related data and transmit the data as signals 150 to the local electronic computing device 115. For instance, a microphone detector transmits signals 150 corresponding to captured audio of a gunshot.

As another example, the camera 125 feeds captured footage in real time (as it is being collected) via footage signals 150 to the local electronic computing device 115. The video analytics module 132 processes the footage signals 150 in real time or in batches. For example, the video analytics module 132 identifies characteristics in the footage (e.g., particular brightness and/or color in groupings of pixels over a certain grouping of footage frames) that are entered as numerical parameters in one or more event categorization algorithms. In some examples, the algorithm(s) could be part of a MLM 134. The algorithm(s) are trained to determine, based on the parameters, and within a predefined confidence, if there is predefined event occurring in the footage or occurring based on other captured data such as captured audio data, and, if so, what type of event it is. The event type can be any of the event types (or other event types) described herein.

Once an event is detected, the computing device 115 generates and transmits event signals 152 that are provided to the remote computing device 130. The event signals 152 carry data (e.g., in one or more data packet payloads) and metadata (e.g., in one or more data packet headers and/or in discrete metadata packets. The data identifies the determined event type, and the metadata provides information surrounding the event, such as any of the metadata information described herein.

The event signals 152 do not include the raw footage data. That is, the remote computing device does not receive the raw footage captured by the camera 125.

The response module 142 processes the event signals 152. In some examples, processing the signals 152 includes inputting the data and metadata provided by the signals 152 as numerical parameters of one or more algorithms. In some examples, the algorithm(s) can be part of a MLM 144. The algorithm(s) are trained to determine, based on the parameters, and within a predefined confidence, what response or responses, if any, to take in response to the event type.

If the response module 142 determines that a response or responses to the event are needed, the remote electronic computing device 130 generates and transmits response signals 156 that are provided via the network 220 to the appropriate response device(s) 110. The response signals 156 can include metadata that identifies the destination device(s) 110 so that the signals are routed to the appropriate response device(s) of the vehicle.

In some examples, the response device 110 includes a controller or other processing device that processes the response signals 156 and causes the response device 110 to behave a certain way to respond to the event, such as any of the responses described herein.

In some examples, the event type and metadata are provided via the event signals 152 as information via an interface (e.g., a speaker, a display) of the remote electronic computing device 130, and a person inputs commands to the remote electronic computing device 130 to cause the remote electronic computing device 130 to generate and transmit the signals 156.

In some examples, the response module 142 causes the data and metadata to be recorded, e.g., in an event log stored on a database that can be referenced later.

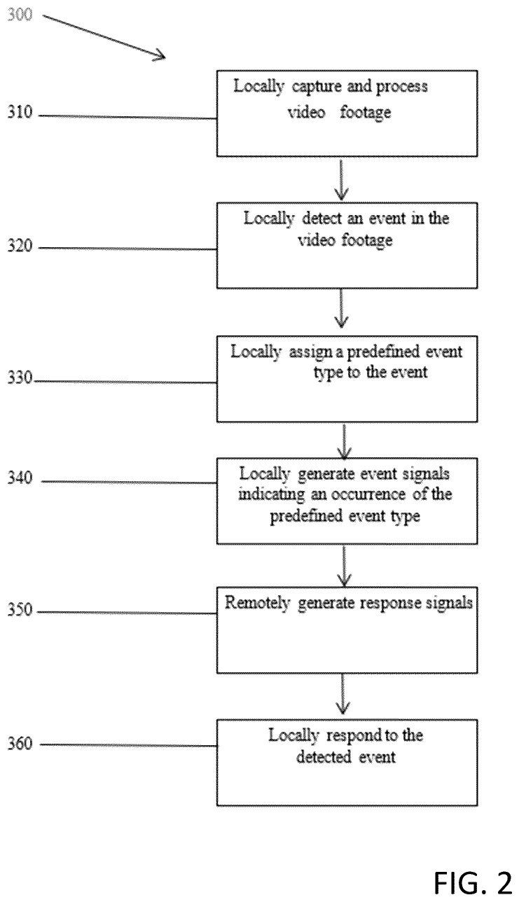

FIG. 2 is an example method 300 that can be performed by the system of FIG. 1.

Example methods need not include all of the enumerated steps of the method 300. Example methods need not be in the order of the enumerated steps of the method 300. The steps of the method 300 can be performed by different computing devices, as described above in connection with FIG. 1. Methods embodied by the method 300 can be performed by individual devices, such as the device 115, the device 130 and the device 110 of FIG. 1.

At the step 310 of the method 300, video footage is locally captured at a vehicle and processed locally at the vehicle.

At the step 320 of the method 300, while processing the footage, a predefined event in the video footage is detected.

At the step 330 of the method 300, the detected event is locally assigned a predefined event type. For example, the event type can be an officer down.

At the step 340 of the method 300, the event signals are locally generated and transmitted to a remote computing device. The event signals can include metadata about the event, such as a location of the event, a time of the event, an identity of the officer who is down, and one or more electronic devices that may be carried on the person of the officer who is down, and the like.

At the step 350 of the method 300, the remote computing device processes the event signals and generates response signals.

At the step 360 of the method 300, the response signals are received and processed, and acted upon locally (e.g., by one or more response devices local to the vehicle). For example, the response signals can cause, among other things, a body worn camera of the officer that is down to activate and begin capturing footage. The response signals can cause additional responses to occur, such as calling for emergency backup to the location where the officer is down.

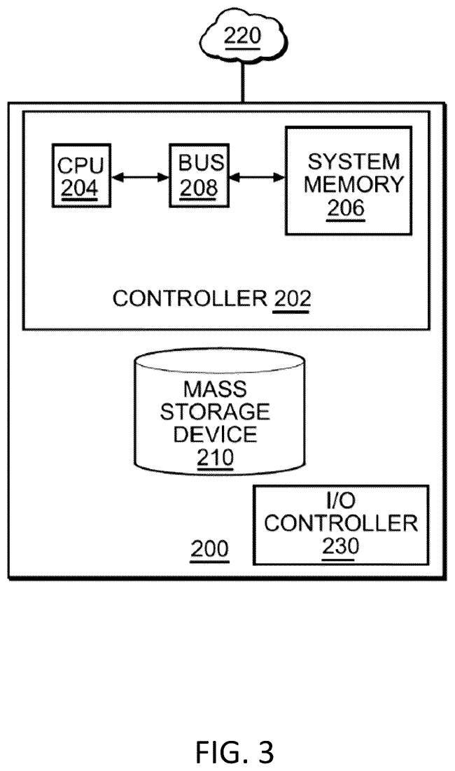

FIG. 3 schematically illustrates an example computing device 200 of the response system for vehicles of FIG. 1. The local electronic computing device 115 can be configured according to the computing device 200. The remote electronic computing device 130 can be configured according to the computing device 200. One or more components of the computing device 200 can be included in the detector(s) 140 and/or the response device(s) 110 of FIG. 1.

The computing device 200 includes a controller 202 having at least one central processing unit (“CPU” or processor) 204, a system memory 206, and a system bus 208 that couples the system memory to the CPU. The system memory includes a random access memory (“RAM”) and a read-only memory (“ROM”). The computing devices can further include a mass storage device 210. The mass storage device 210 is able to store software instructions and data such as the video analytics module 132 and the response module 142. The CPU 204 can correspond to any of processors described herein.

The computing device includes connected to the network 220.

The mass storage device 210 and its associated computer-readable data storage media provide non-volatile, non-transitory storage for the computing device 200. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central processing unit can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing devices.

The system 100 of FIG. 1 can operate in a networked environment using logical connections to remote network devices through a network, such as a wireless network, the Internet, or another type of network 220. The computing device(s) 200 may also include an input/output controller 230 for receiving and processing input from other devices, including a touch user interface display screen, or another type of input device (e.g., a microphone). Similarly, the input/output controller 230 may provide output to a touch user interface display screen or other type of output device (e.g., a speaker).

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A system for responding to events, comprising:
a vehicle;
a camera mounted to the vehicle, the camera being configured to capture video footage;
a first electronic computing device mounted to the vehicle, the first electronic computing device including:
at least one processor; and
memory encoding instructions which, when executed by the at least one processor, cause the first electronic computing device to:
process, by the at least one processor, the video footage and, based thereon:
(i) detect an event in the video footage to provide a detected event; and
(ii) assign a predefined event type to the event;
transmit first signals to a second electronic computing device that is remote from the vehicle, the first signals indicating an occurrence of the predefined event type;
process, by the at least one processor, second signals transmitted from the second electronic computing device; and
based on the second signals, cause a device associated with the vehicle to respond to the detected event with a response.

2. The system of claim 1, wherein the second electronic computing device does not receive the video footage.

3. The system of claim 1, wherein the device associated with the vehicle includes one or more of a camera, a smartphone, a controller that controls a movement of the vehicle or a part of the vehicle, a microphone, and an electronic speaker.

4. The system of claim 1, further comprising a dedicated housing mounted to the vehicle and that houses the camera and the first electronic computing device.

5. The system of claim 1, wherein the vehicle is an emergency vehicle.

6. The system of claim 1, wherein the first signals include metadata relating to an event corresponding to the event type.

7. The system of claim 6, wherein the metadata includes a time stamp for the event in the video footage.

8. A system for responding to events, comprising:
a first electronic computing device, including:
at least one processor; and
memory encoding instructions which, when executed by the at least one processor, cause the first electronic computing device to:
process, by the at least one processor, first signals transmitted from a second electronic computing device mounted to a vehicle that is remote from the first electronic computing device, the first signals indicating an occurrence within a visual range of the vehicle of a predefined event type, the occurrence being determined from video footage; and
generate second signals configured to cause a device associated with the vehicle to respond to the detected event with a response, the second signals being generated based on the predefined event type.

9. The system of claim 8, wherein the second electronic computing device does not receive the video footage.

10. The system of claim 9, wherein the device associated with the vehicle includes one or more of a camera, a smartphone, a controller that controls a movement of the vehicle or a part of the vehicle, a microphone, and an electronic speaker.

11. The system of claim 8, wherein the vehicle is an emergency vehicle.

12. The system of claim 8, wherein the instructions, when executed by the at least one processor, cause the first electronic computing device to record the predefined event type and metadata of an event corresponding to the predefined event type.

13. The system of claim 8, wherein the first signals include metadata relating to an event corresponding to the event type.

14. A system for responding to events, comprising:
a vehicle;
a response device associated with the vehicle;
a camera mounted to the vehicle, the camera being configured to capture video footage;
a first electronic computing device mounted to the vehicle and including at least one first processor; and
a second electronic computing device that is remote from the vehicle and including at least one second processor,
the first electronic computing device including memory encoding first instructions and the second electronic computing device including memory encoding second instructions which, when executed by the at least one first processor and the at least one second processor, respectively, cause the first electronic computing device and the second electronic computing device to:
process, by the at least one first processor, the video footage and, based thereon:
(i) detect, by the at least one first processor, an event in the video footage to provide a detected event; and
(ii) assign, by the at least one first processor, a predefined event type to the event;
generate, by the first electronic computing device, first signals indicating an occurrence of the predefined event;
transmit, by the first electronic computing device, the first signals to the second electronic computing device;
generate, by the second electronic computing device, second signals based on the predefined event type;
transmit, by the second electronic computing device, the second signals;
process, by the at least one first processor, the second signals; and
based on the second signals, generate, by the first electronic computing device, third signals,
wherein the response device is configured to receive the third signals and, based on the third signals, to respond to the detected event with a response; and
wherein the video footage is not provided to the second electronic computing device.

15. The system of claim 14, further comprising a dedicated housing mounted to the vehicle and that houses the camera and the first electronic computing device.

16. A system for responding to events, comprising:
a vehicle;
a visual sensor array mounted to the vehicle, the visual sensor array being configured to capture video footage;
a first electronic computing device mounted to the vehicle, the first electronic computing device including:
at least one processor; and
memory encoding instructions which, when executed by the at least one processor, cause the first electronic computing device to:
process, by the at least one processor, the video footage to encode the video footage as a numerical data stream and, based thereon:
(i) detect an event in the numerical data stream to provide a detected event; and
(ii) assign a predefined event type to the event;
transmit first signals to a second electronic computing device that is remote from the vehicle, the first signals indicating an occurrence of the predefined event type;
process, by the at least one processor, second signals transmitted from the second electronic computing device; and
based on the second signals, cause a device associated with the vehicle to respond to the detected event with a response.

17. The system of claim 16, wherein the second electronic computing device does not receive the video footage.

18. The system of claim 16, wherein the device associated with the vehicle includes one or more of a camera, a smartphone, a controller that controls a movement of the vehicle or a part of the vehicle, a microphone, and an electronic speaker.

19. The system of claim 16, wherein the vehicle is an emergency vehicle.

20. The system of claim 16,
wherein the first signals include metadata relating to an event corresponding to the event type; and
wherein the metadata includes a time stamp for the event in the video footage.
